(19) United States
(12) Patent Application Publication
(10) Pub. No.: US 2023/0192535 A1
(43) Pub. Date: Jun. 22, 2023

(54) METHOD FOR INTRODUCING A RECESS INTO A SUBSTRATE

(71) Applicant: LPKF Laser & Electronics AG, Garbsen (DE)

(72) Inventors: Norbert Ambrosius, Garbsen (DE); Roman Ostholt, Langenhagen (DE); Daniel Dunker, Hannover (DE); Moritz Doerge, Uetze (DE); Kevin Hale, Burgdorf (DE); Aaron Michael Vogt, Hannover (DE)

(21) Appl. No.: 17/927,012

(22) PCT Filed: Mar. 31, 2021
(86) PCT No.: PCT/EP2021/058498

§ 371 Date: Nov. 22, 2022

(30) Foreign Application Priority Data
May 27, 2020 (DE) 10 2020 114 195.5

(51) Int. Cl. C03C 15/00; B23K 26/53; B23K 26/00

(52) U.S. Cl. CPC C03C 15/00; B23K 26/53; B23K 26/0006; B23K 2103/54

(57) ABSTRACT

A method for introducing a recess into a substrate, and/or for reducing a material, includes spatially beam shaping a focus of a laser beam along a beam axis, whereby defects are produced in the substrate along the beam axis without there being any material removal. One or more of the defects forms a modification in the substrate, so that subsequently the recess and/or the material thickness reduction is produced by action of an etching medium by an anisotropic material removal. An additional modification is introduced into the substrate along an additional beam axis that is parallel to and spaced from the beam axis, the additional modification having an extent between a first outer surface of the substrate and a position within the substrate that is at a distance from a second, opposite outer surface of the substrate.

### CROSS REFERENCE TO RELATED APPLICATIONS

This application is a U.S. National Phase application under 35 U.S.C. § 371 of International Application No. PCT/EP2021/058498, filed on Mar. 31, 2021, and claims benefit to German Patent Application No. DE 10 2020 114 195.5, filed on May 27, 2020. The International Application was published in German on Dec. 2, 2021 as WO 2021/239302 A1 under PCT Article 21(2).

### FIELD

The invention relates to a method for introducing at least one non-continuous recess as a blind hole without a perforation into a substrate, in particular a plate-shaped substrate, or for reducing the material thickness of the substrate as a material weakening, in which the focus of a laser beam undergoes a spatial beam shaping along a beam axis of the laser beam and in which defects are produced in the substrate by means of the laser beam along the beam axis, without material removal from the substrate as a result of the laser radiation, one or more defects forming at least one modification in the substrate, so that subsequently the recess or the material weakening is produced by the action of an etching medium and by successive etching by an anisotropic material removal in the respective region of the modifications in the substrate.

### BACKGROUND

The generic process for precision machining of glass by means of laser-induced deep etching has become known as LIDE (Laser Induced Deep Etching). The LIDE process enables the forming of extremely precise holes and structures at highest speed and thus establishes the prerequisites for the increased use of glass as a material in microsystems technology.

In laser-induced deep etching, known for example from WO 2014/161534 A2 and WO 2016/004144 A1, a transparent material is modified by means of a laser pulse or pulse train over an elongated region along the beam axis, often over the entire thickness of the transparent material, for example in the case of glass plates, so that the modification is etched anisotropically in a subsequent wet chemical etching bath.

From WO 2016/041544 A1 a method is known for introducing a recess, for example a blind hole, into a plate-shaped substrate by means of laser radiation, whereby an anisotropic material removal occurs in the modified regions of the substrate due to the action of an etching medium by successive etching.

However, the laser-induced etching processes are disadvantageous in that single-sided etching, for example to produce blind holes or other recesses on one side, requires additional measures to protect the opposite outer surface of the substrate, and in that modifications passing between the opposite sides also change the material properties of the substrate on the outer surface of the substrate facing away from the recess.

EP 2 503 859 A1 describes a selective laser etching process in which the glass substrate is irradiated with a laser focused on a focal point at a desired position within the glass substrate. By immersing the glass substrate in an etching solution so as to remove the modified areas from the glass substrate, complex 3D structures in glass or blind holes can be fabricated. The etch removal process requires that individual volumes, for example of size 10×10×10 μm³, be modified, for which the focal point in the glass substrate must be realigned accordingly. Although volumes thus modified can be combined in any way, this is associated with a high level of time and control effort.

DE 10 2018 110 211 A1 describes a method in which the focal position and depth in a substrate are controllable to create filamentary damage as a very fine blind hole of varying length in the substrate. This filamentary damage is enlarged in diameter by subsequent isotropic etching to create a cavity with a complex geometry by joining at least two mutually adjacent filaments.

DE 10 2011 111 998 A1 relates to a method for structuring a surface, wherein the surface is irradiated with a laser and is regionally modified, for example in a region below the surface. In an etching process, depressions are created or enlarged in the surface in the modified regions. The laser irradiation causes a change in the material, which leads to a change in the effect of the etchant. The change in the material can be micro-dislocations, micro-cracks, micro-bores, micro-recesses or a phase change, whereby, for example, a structural change or also a melting can be achieved by the laser irradiation.

EP 2 600 411 A1 describes irradiating a substrate with laser light to create a plurality of modified regions within the substrate and anisotropically etching the surface such that recesses and protrusions are formed on the surface of the substrate. The modified regions are generated by irradiating the substrate with laser light a plurality of times while changing the distance between the surface of the substrate and a convergence point of the laser light.

In addition, anisotropic etching is also known from US 2012/0 295 066 A1.

Furthermore, DE 10 2014 109 792 A1 relates to a method in which a punctiform surface damage is produced on a surface of the element made of glass along a parting line, at least in sections, which damage projects into the element. For this purpose, a laser shot is made on the surface of the element by means of laser radiation in order to generate a blind hole or a plurality of point-shaped blind holes or a line-shaped laser track. A line-shaped surface damage can be produced by stringing together blind holes which abut one another in the region of their openings or, particularly advantageously, overlap.

### SUMMARY

In an embodiment, the present invention provides a method for introducing at least one recess into a substrate, and/or for reducing a material thickness of the substrate. The method includes spatially beam shaping a focus of a laser beam along a beam axis of the laser beam. Defects are produced by laser radiation of the laser beam in the substrate along the beam axis without there being any material removal of the substrate as a result of the laser radiation, wherein one or more of the defects forms at least one modification in the substrate, so that subsequently the at least one recess and/or the material thickness reduction is produced by action of an etching medium by an anisotropic material removal in a respective region of the at least one modification in the substrate. At least one additional modification is introduced into the substrate along at least one additional beam axis that is parallel to and spaced from the beam axis, the at least one additional modification having an extent between a first outer surface of the substrate and a position within the substrate that is at a distance from a second outer surface of the substrate opposite the first outer surface.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a side view of a substrate having a modification, which extends to a position within the substrate;

FIG. 2 is a modification in the substrate produced by etching;

FIG. 3 shows several modifications arranged side by side with several recesses overlapping due to the etching process;

FIG. 4 is a top view of the substrate having a corrugated edge contour produced by a plurality of adjacent recesses;

FIG. 5 shows a regular pattern of modifications and recesses;

FIG. 6 is a top view of a substrate having a plurality of modifications arranged in rows;

FIG. 7 is a sectional side view of the substrate shown in FIG. 6 with several modifications of different extents;

FIG. 8 is a sectional side view of the substrate shown in FIGS. 6 and 7 after material removal by etching;

FIG. 9 is a sectional side view of a further substrate having a plurality of modifications partially introduced along the same axes; and

FIG. 10 a sectional side view of the substrate shown in FIG. 9 after the removal of material by etching.

### DETAILED DESCRIPTION

Embodiments of the present invention substantially reduce the effort required for the production of recesses in a substrate by laser-induced etching.

According to an embodiment of the invention, a method is provided in which a plurality of modifications are introduced into the substrate along, in particular, parallel spaced beam axes, the beam axes having a lateral distance between a minimum and a maximum from one another, such that each modification extends from a first outer surface in the direction of the opposite second outer surface of the substrate to a position lying between the outer surfaces at a distance from the opposite outer surface. An aspect of embodiments of the present invention is based the creating of a modification which does not extend over the entire material thickness of the substrate, but only from an outer surface to a region lying between the outer surfaces. This allows a one-sided recess to be introduced without a cover, for example an etch resist by immersion in an etch bath, whereby the substrate is etched anisotropically in the region of the modifications and isotropically in the remaining regions. By not allowing the modifications to extend to the opposing outer surface, the properties of the substrate at that outer surface remain unchanged, opening up a variety of applications that have previously been limited. In addition, it has been found that the spatial beam shaping and the resulting uniform, continuous and uninterrupted modification from the outer surface to the predetermined position within the substrate make it possible to achieve a much more homogeneous etch removal than is the case with such processes in which several volumes with correspondingly changed focal positions are introduced one after the other along a beam axis. In addition, the process time and the control effort can be reduced considerably by moving the laser beam exclusively parallel to the surface of the substrate during processing, i.e. only the desired contour has to be traversed without changing the focus. The energy input of the laser beam serves to excite or trigger a reaction and to generate defects, which in total or in each case form modifications, the effect of which only leads to or is used in the subsequent process step by the action of an etching medium to achieve the desired material removal.

According to embodiments of the present invention, defects are created in the substrate by means of the laser radiation and at least one modification is formed in the substrate, which, however, does not result in any material removal per se. Subsequently, i.e. without a previous material removal, the recess or the material weakening are produced by the action of an etching medium by an anisotropic material removal in the respective region of the modifications in the substrate. The material removal therefore occurs exclusively as a result of the etching effect of the etching medium and not as a direct consequence of the action of the laser radiation.

According to an embodiment of the invention, a particularly advantageous effect is also produced by the fact that the resulting recesses have a very low roughness or waviness in the region of their front-end boundary surface, which preferably runs parallel to the outer surface. The overhang structures that can be produced in this way thus have a previously unattained homogeneous material thickness.

Of course, the use of a cover, in particular an etching resist, does not necessarily have to be dispensed with in accordance with an embodiment of the invention if, for example, individual areas are to be protected from undesirable etching abrasion. Even a merely one-sided etching effect can be realized without any problems and is an object of the invention.

In this context, it is particularly practical if the substrate is immersed in an etching bath, i.e. is etched in particular without a cover or an etching resist, so that the etching attack results in anisotropic material removal on the first outer surface and isotropic material removal on the second outer surface. In this way, for example, recesses opposite each other can also be introduced into the outer surfaces, which are separated only by a thin membrane, whereby the plane of the membrane can of course also deviate from the central plane between the outer surfaces. Such structures cannot be realized with previous methods or only at great expense by means of multi-stage etching processes.

A particularly advantageous embodiment of the invention is achieved in that the modifications are introduced by a plurality of pulses with a coinciding beam axis, wherein at least individual pulses are introduced with an energy input below a threshold value for the modification and cause only an excitation of the affected substrate material, and the cumulative energy input produces the modification. The changes of state introduced along the same beam axis cause the resulting modification to widen in the cross-sectional plane with respect to the beam axis, or to blunt the cone angle, such that the recess is ideally cylindrical. In this way, a substantially planar boundary surface of the recess is achieved, in contrast to the prior art in which adjacent modifications result in conical depressions in the plane of the recess when the etching process is carried out. Since each pulse alters the optical properties of the substrate by the excitation effected and thereby causes a scattering which results in a widening of the zone of influence concentrically about the beam axis, the volume limited thereby grows in width transversely to the beam axis. At the same time, this results in an end face running in the cross-sectional plane or a slightly conical depression with an obtuse or shallow angle. The result is a shaping of the modification, the length of which remains constant, but the diameter of which is determined by the number and parameters of the pulses.

One could think of selecting the distance of adjacent beam axes in such a way that overlapping of the modifications results. On the other hand, it is particularly useful if the distance of the beam axis is set in such a way that the introduced modifications do not overlap each other, but are adjacent to each other with a small distance, so that the recesses created by the anisotropic material removal in the modified areas overlap each other transversely to the beam axis.

In order to avoid undesirable interactions when introducing adjacent modifications, so-called shadowing effects, for the laser radiation by preceding modifications, the spacing of the modifications (p) is determined as a function of the diameter of the etched recesses (d) according to the formula 10>d/p>1.15. Thus, the diameter (d) of the respective recess is at least 1.15 times as large as the spacing of the modifications (p), so that a coherent volume is formed. At the same time, however, a minimum spacing of the modifications (p) must be maintained, which must not be smaller than one tenth of the diameter, otherwise edge effects due to shadowing will occur.

In this respect, it has already proved to be particularly expedient if the modifications are introduced into the substrate with a regular pattern and/or a regular structure. This results in a uniform pattern in the surface defining the recess, whereby in particular undesirable material weakening is avoided and the properties of the surface are largely homogeneous over the entire extent of the recess.

For this purpose, it proves to be particularly practical if the distance of a modification from all adjacent modifications is selected to be at least substantially the same, so that, for example, a hexagonal structure of the modifications results. It can also be advantageous not to introduce the successive modifications in the order of adjacent modifications, but if necessary to introduce modifications that are further away first. This avoids, in particular, interactions due to thermal influences.

A particularly advantageous embodiment of the invention is also achieved in that at least individual ones of the mutually adjacent modifications, in particular parallel modifications have different lateral distances in a common transverse plane parallel to the outer surface, and in that the respective lateral distance is set as a function of the extent, that is to say the length of the modification between the outer surface and the position in the substrate, in such a way that, in the case of a greater extent, the lateral distance is reduced and vice versa, so that the lateral distance and the extent are thus inversely proportional. Surprisingly, it has been shown that the recess or weakening of the material thus produced has a regular surface, in practice almost flat, when this relationship between the lateral distance and the elongation is exhibited, which is not the case when the lateral distance is independent of the elongation. This effect, which can be used according to an embodiment of the invention, is based on the realization that in an end portion of the modification near the position in the substrate, the cross-sectional area of the modification is reduced, which has its cause in a converging course of the modifications. An optimal area can therefore be obtained by a reciprocal relationship between the extent and the lateral distance of adjacent modifications.

Another, also particularly preferred, embodiment of the invention is achieved when different modifications are introduced into the substrate section by section along identical or parallel axes, which may extend between the first outer surface and a position within the substrate on the one hand, and between the second outer surface and a position within the substrate on the other hand, and the extent of which may be coincident. Thus, a three-dimensional contour can be generated in the substrate, wherein the laser radiation enters the substrate through the same outer surface. Thereby, the respective modification extends from the first or the second outer surface to the predetermined position within the substrate. The etching attack by the action of an etching medium takes place from both sides, in particular by immersion in the etching medium, so that material is removed on both sides or on all sides. In this way, even complex structures can be created with comparatively little effort by introducing the modifications and subsequent etching.

According to a particularly promising embodiment of the method according to the invention, in which modifications between, on the one hand, a position within the substrate and, on the other hand, either the first outer surface or the second outer surface are introduced into the substrate with the same extent or with the same distance from the adjacent outer surface along identical axes, a rounding of parting surfaces can be carried out, for example by chamfers on both sides along the circumferential contour of a cut-out to be produced from the substrate. Thus, the cutting out along the target contour and the insertion of chamfers to avoid undesired sharp edges are performed in a single process step.

In another, also particularly useful, embodiment of the method of the invention, a plurality of adjacent modifications introduced into the substrate along parallel axes are each introduced at different positions within the substrate and at different distances from the adjacent outer surface, the positions lying on a common plane which is not parallel to the outer surface. In this manner, a planar material weakening or recess can thus be created with an orientation inclined with respect to the outer surface.

Of course, curved surfaces can also be created in the same way, in particular to avoid discontinuity points in a transition region of the recess and in adjacent edge regions of the substrate. In this way, undesirable stress curves within the substrate, in particular in the event of an external force being applied, are efficiently avoided and the load-bearing capacity of the structure thus produced, such as an overhang structure, is substantially increased.

In this way, at least individual recesses and/or material weakening with a residual thickness of the substrate of less than 100 μm, in particular for example approx. 50 μm, can be introduced into a substrate, for example of glass with a material thickness between 300 μm and 900 μm, in particular approx. 500 μm, so that flexible properties can be achieved at least in the region of individual recesses or material weakening and thereby, for example, membranes or hinges can be produced.

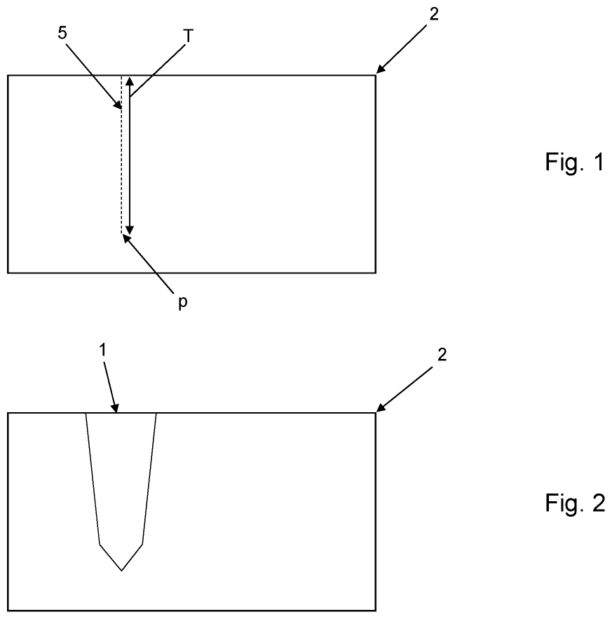

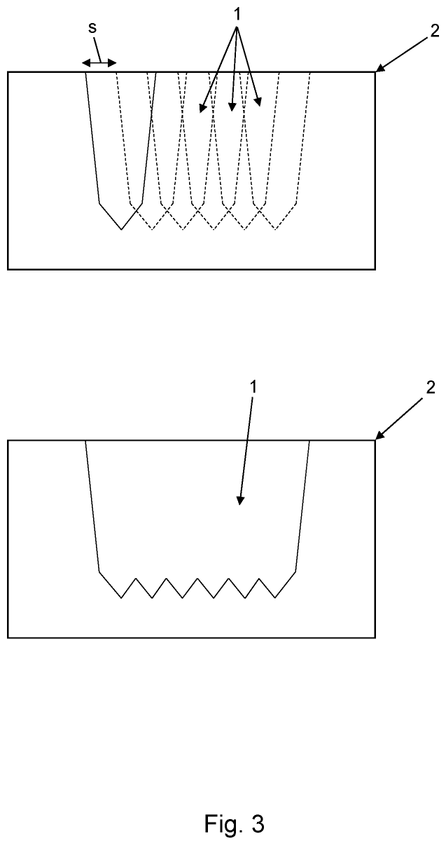

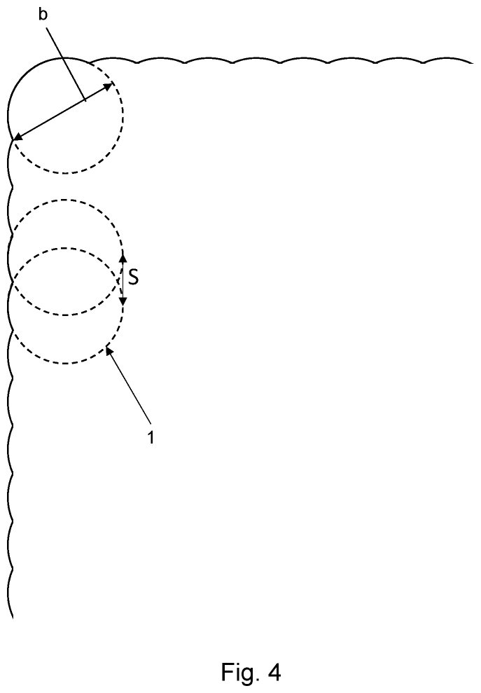

The method according to an embodiment of the invention for introducing a recess 1 as a depression or overhang structure into a substrate 2 by partially reducing the material thickness 3 of the substrate 2 is explained in more detail below with reference to the figures. In this process, as can be seen in FIG. 1, according to the LIDE process (Laser Induced Deep Etching) known per se, a spatial beam shaping of the laser radiation, which is not shown, occurs along a beam axis 4 in the substrate 2, as a result of which defects are produced in the substrate 2 along the beam axes 4, which in each case form a modification 5 in the substrate 2.

Subsequently, as shown in FIG. 2, the recess 1 is created in the substrate 2 by the action of an etching medium and by the consequent anisotropic removal of material in the respective region of the modifications 5.

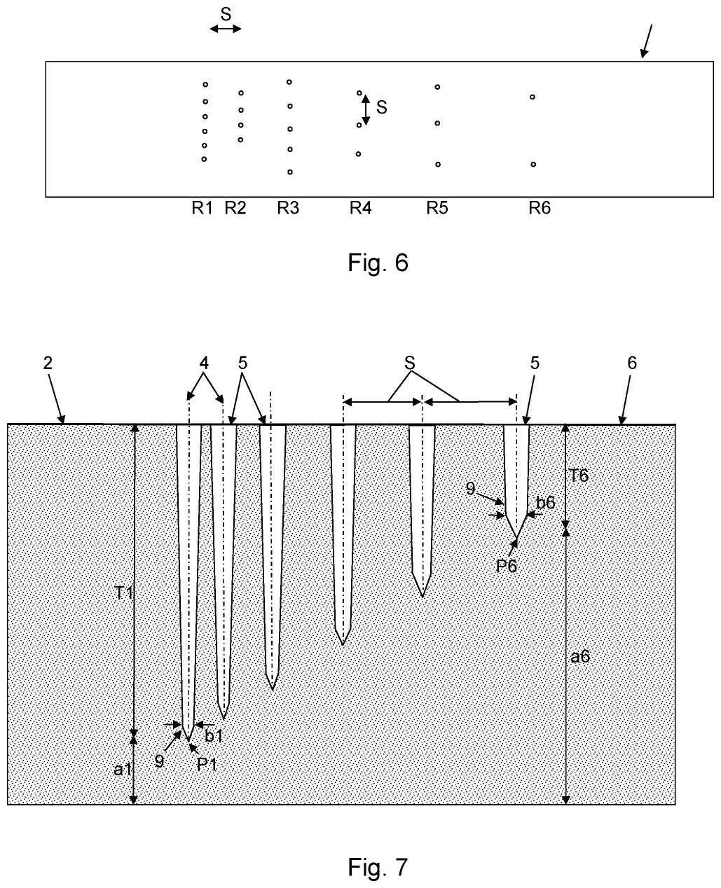

As can be seen in particular in FIGS. 6 and 7, for this purpose a plurality of modifications 5 is introduced into the substrate 2 along parallel beam axes 4 with an extent T between a first outer surface 6 and a position P within the substrate 2 at a distance a from a second outer surface 7 opposite the first outer surface 6, so that each modification 5 extends from an outer surface 6, 7 in the direction of the opposite outer surface 6, 7 of the substrate 2 to a position P within the substrate 2. In this case, the mutually adjacent modifications 5 have a lateral distance S with respect to the respective beam axis 4.

In the region of the modifications 5, the etch ablation creates overlapping recesses 1 that create a pocket-like depression or overhang structure in the substrate 2 with a ripple at the bottom of the recess 1. The remaining thickness in the region of the pocket-like recesses 1 forms the overhang structure.

FIG. 4 shows an enlarged top view of an edge region of the recess 1. The typical shape of the edge region is created by the lateral distance S between the modifications 5 and the size of the etched recesses 1, characterized by the width b, which at the same time determines the radius in one corner of the edge region.

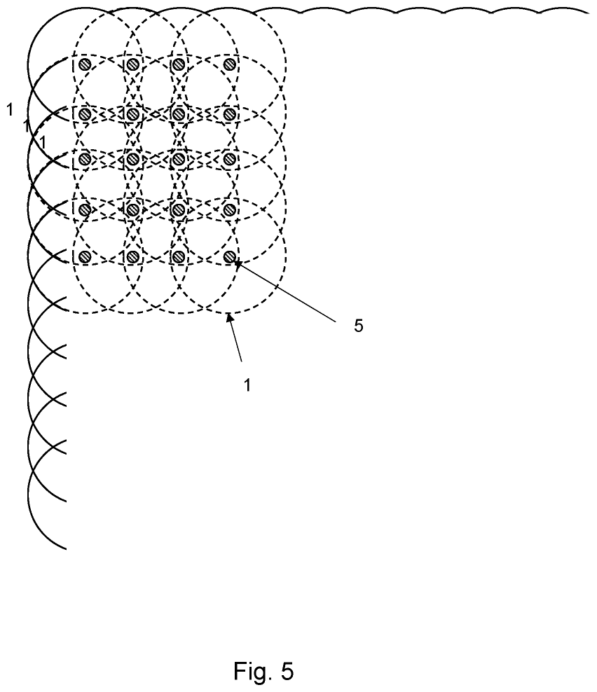

In addition, FIG. 5 shows in a top view the regular pattern of modifications 5 and recesses 1 in the edge region of recess 1.

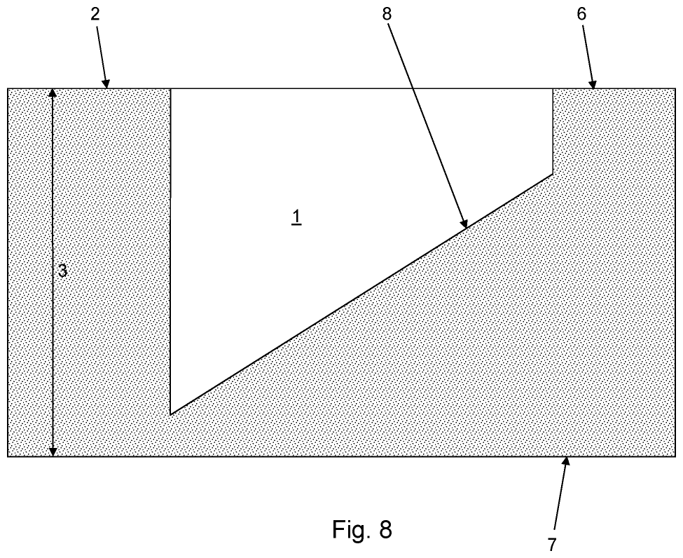

The lateral distance S of adjacent modifications 5 is inversely proportional to the length or depth respectively, of the extent T in the substrate 2. As can be seen in FIG. 6, this applies both to the lateral distance S of a modification 5 of a row R to the modifications 5 of the adjacent rows R and to the respective lateral distance S of different modifications 5 of the same row R from one another. Thus, according to an embodiment of the invention, it is possible to produce a virtually flat surface 8 of the recess 1 shown in cross-section in FIG. 8, in that the method according to an embodiment of the invention makes use of the different cross-sectional shapes depending on the extent T of the modifications 5 and their width b of the modifications 5 in their respective end region 9.

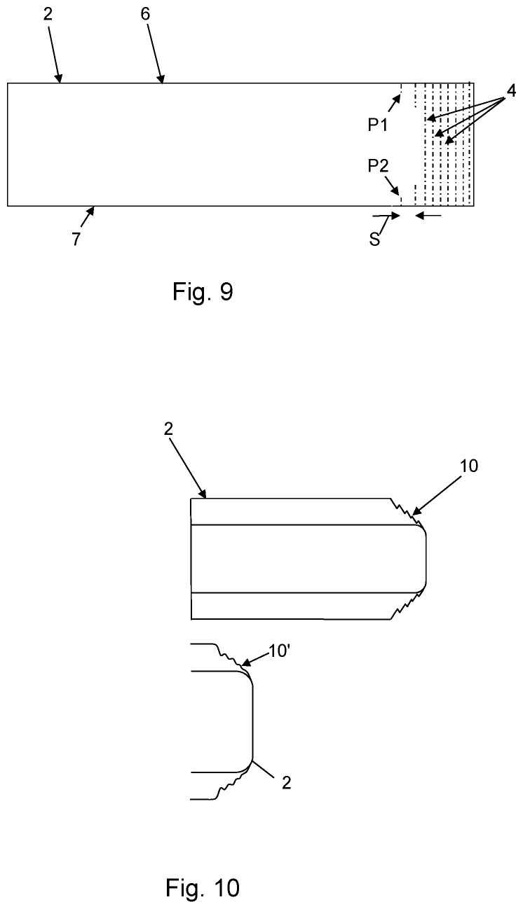

FIGS. 9 and 10 show another variant of the method in which different modifications 5 are introduced into the substrate 2 along the same beam axis 4 of the laser radiation, which modifications extend on the one hand between the first outer surface 6 and a first position P1 and on the other hand between the second outer surface 7 and a second position P2 within the substrate 2, the modifications 5 having the same extent T in the exemplary embodiment shown. Thus, by creating an interruption of the modifications 5 along the beam axis 4, the inner region of the substrate 2 thus enclosed remains free from a material removal during the subsequent etching treatment. The staircase-like structure thus produced after the etching ablation is shown in FIG. 10, which due to chemical effects obtains the rounded contour 10′ shown in supplementary detail. The rounded contour or chamfer thus produced is ideally suited for the production of loadable cutouts or blanks of the substrate 2 and, according to an embodiment of the invention, can be produced in a single common process step.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Recess

2 Substrate

3 Material thickness

4 Beam axis

5 Modification

6 Outer surface

7 Outer surface

8 Surface

9 End region

10 Contour

T Extent

P Position

a Distance

S Lateral distance

R Row

b Width

1. A method for introducing at least one recess into a substrate, and/or for reducing a material thickness of the substrate, the method comprising:
spatially beam shaping a focus of a laser beam along a beam axis of the laser beam;
producing defects, by laser radiation of the laser beam, in the substrate along the beam axis, without there being any material removal of the substrate as a result of the laser radiation, wherein one or more of the defects forms at least one modification in the substrate, so that subsequently the at least one recess and/or the material thickness reduction is produced by action of an etching medium by an anisotropic material removal in a respective region of the at least one modifications in the substrate; and
introducing at least one additional modifications into the substrate along at least one additional beam axis that is parallel to and spaced from the beam axis, the at least one additional modification having an extent between a first outer surface of the substrate and a position within the substrate that is at a distance from a second outer surface of the substrate opposite the first outer surface.

2. The method according to claim 1, wherein the substrate is immersed in an etching bath so that an etching attack causes the anisotropic material removal in the respective region of the at least one modification and anisotropic material removal in a respective region of the at least one additional modification at the first outer surface, and causes isotropic material removal at the second outer surface.

3. The method according to claim 1, wherein the defects within the substrate are generated by a sequence of pulses or by a single pulse.

4. The method according to claim 1, wherein the at least one modifications is introduced by several pulses of the least beam with a coinciding beam axis.

5. The method according to claim 1, wherein a lateral distance of the spacing of the at least one additional beam axis from the beam axis is set in such a way that the at least one additional modifications does not overlap the at least one modification.

6. The method according to claim 1, wherein a lateral distance of the spacing of the at least one additional beam axis from the beam axis is set in such a way that the at least one recess formed by the anisotropic removal of material in the respective regions of the at least one modifications overlaps the at least one additional recess formed by anisotropic removal of material in a respective region of the at least one additional modification.

7. The method according to claim 1, wherein the at least one additional modification includes a plurality of additional modifications, and wherein the at least one modifications and the plurality of additional modifications are introduced into the substrate with a regular pattern and/or with a regular structure.

8. The method according to claim 1, wherein a lateral distance of the beam axes of the plurality of additional modifications from the beam axis and/or from each other for all of the modifications that are adjacent to each other is selected to be at least substantially coincident.

9. The method according to claim 1, wherein the plurality of additional modifications have different extents from each other and/or the at least one modification, and wherein the modifications that have a greater extent have a reduced lateral distance to adjacent ones of the modifications.

10. (canceled)

11. The method according to claim 1, wherein the plurality of additional modifications are each introduced into the substrate between the first outer surface and the same position within the substrate so as to have the same extent and/or the same distance to the second outer surface.

12. The method according to claim 1, a wherein the plurality of additional modifications are each introduced into the substrate along parallel beam axes such that each of the additional modifications extends to a different positions within the substrate at a different distances from the second outer surface, the positions lying on a common plane which is not parallel to the outer surfaces.

13. The method according to claim 1, wherein the substrate is plate-shaped and has a material thickness between 300 μm and 900 μm, and wherein the at least one recess and/or the material thickness reduction is introduced with a residual thickness of the substrate of less than 100 μm.

14. The method according to claim 13, wherein the material thickness is between 300 μm and 600 μm, and wherein the residual thickness of the substrate in the respective region of the at least one recess and/or material thickness reduction is between 30 μm and 80 μm.

15. The method according to claim 1, wherein the at least one modification extends from one of the outer surfaces towards the opposite outer surface of the substrate to a position within the substrate at a distance from the outer surfaces.

16. The method according to claim 15, wherein the at least one modification extends from the first outer surface towards the second outer surface of the substrate to a position within the substrate at a distance from the second outer surface.

17. The method according to claim 1, further comprising producing at least one additional recess and/or at least one additional material thickness reduction by the action of the etching medium, or by action of another etching medium, by additional anisotropic material removal in a respective region of the at least one additional modification in the substrate.

18. The method according to claim 17, wherein the at least one modification extends from the first outer surface towards the second outer surface of the substrate to a position within the substrate at a different distance from the second outer surface than the at least one additional modification, and wherein the at least one recess and the at least one additional recess are produced by the action of the etching medium(s) such that the recesses have different extents into the substrate.

19. The method according to claim 1, further comprising introducing a further modification along the same additional beam axis extending from the second outer surface to a second point in the substrate that is at a distance from the point and the first outer surface.
